(19) United States
(12) Patent Application Publication
(10) Pub. No.: US 2021/0115913 A1
(43) Pub. Date: Apr. 22, 2021

(54) FLOW REGULATING VALVE AND COMPRESSOR

(71) Applicant: Danfoss (Tianjin) Ltd., Tianjin (CN)

(72) Inventors: Lixin Han, Tianjin (CN); Xiaodong Wang, Tianjin (CN); Kun Qian, Tianjin (CN); Haiyun Ma, Tianjin (CN); Wenhu Yao, Tianjin (CN); Yanbo Zhao, Tianjin (CN); Kang Zheng, Tianjin (CN)

(21) Appl. No.: 17/060,326

(22) Filed: Oct. 1, 2020

(30) Foreign Application Priority Data
Oct. 18, 2019 (CN) 201921758623.X

(51) Int. Cl. F04B 49/22; F04D 27/00; F16K 15/06

(52) U.S. Cl. CPC F04B 49/225; F16K 15/063; F04D 27/003

(57) ABSTRACT

A flow regulating valve and a compressor with the flow regulating valve are disclosed. The flow regulating valve includes: a valve seat in which a passage is formed to allow fluid to enter; a guide member protruded outwards from the valve seat; a piston which is disposed on the outside of the valve seat, forms a fluid inlet with the valve seat, and is capable of being reciprocated along the guide member; and a biasing member biasing the piston in a direction away from the valve seat. A force exerted by the incoming fluid on the piston is opposite in direction to a biasing force exerted by the biasing member on the piston. The piston is able to be moved to different positions under the action of different forces to form fluid inlets of different widths with the valve seat, thereby controlling the mass flow rate of the incoming fluid (especially liquid). With the technical solutions of the present invention, the flow rate of the fluid entering the compressor can be effectively adjusted with a simple structure and low cost.

### CROSS-REFERENCE TO RELATED APPLICATION

This application claims foreign priority benefits under 35 U.S.C. § 119 to Chinese Patent Application No. 201921758623.X filed on Oct. 18, 2019, the content of which is hereby incorporated by reference in its entirety.

### BACKGROUND OF THE INVENTION

### Technical Field

The present invention relates to a flow regulating valve and a compressor with the flow regulating valve.

### Background

Under extreme operating conditions, fluid entering a compressor sometimes contains refrigerant liquid. The liquid is incompressible and may cause mechanical damage inside the compressor. In order to solve this problem, in the prior art, generally a larger suction chamber is used or a labyrinth section is disposed in a suction path to reduce the flow rate of liquid entering the compressor. However, with these technical solutions, the compressor is usually complicated in structure, large in size and high in cost.

Therefore, it is desirable to obtain a device that effectively adjusts the flow rate of the incoming fluid with a simple structure and low cost.

### SUMMARY

### Technical Problem

The present invention has been made in order to solve the above technical problems and other potential technical problems.

### Technical Solution

In accordance with an aspect of the present invention, there is provided a flow regulating valve, characterized in that the flow regulating valve is able to form fluid inlets of different widths according to different forces exerted on the flow regulating valve by an incoming fluid.

In particular, the flow regulating valve includes a valve seat, a guide member, a piston, and a pipe. The valve seat, the piston, and the pipe form a fluid regulating passage, and the piston is movable away from or towards the valve seat along the guide member such that a narrowest section of the fluid regulating passage is changed in width and/or in position.

In particular, the flow regulating valve further includes a biasing member. Both a biasing force generated by the biasing member and the force generated by the incoming fluid act on the piston such that the piston is moved along the guide member and finally reaches an equilibrium state.

In particular, the width of the narrowest section of the fluid regulating passage is determined by the piston and the valve seat or by the piston and the pipe.

In particular, the guide member is independent of the piston and the valve seat, or the guide member and the piston are an integral member formed by an integrally molding process, or the guide member and the valve seat are an integral member formed by an integrally molding process.

In particular, the biasing member is abutted against the piston such that the biasing force acts directly on the piston.

Alternatively, the flow regulating valve further includes a linkage member, the linkage member is disposed between the biasing member and the piston and is able to be linked with the piston. The biasing member is abutted against the linkage member such that the biasing force acts on the linkage member.

In particular, the biasing member includes a spring. The smaller the force exerted by the incoming fluid on the piston is, the greater the width of the fluid inlet formed by the piston and the valve seat is.

In accordance with another aspect of the present invention, there is provided a flow regulating valve, characterized in that the flow regulating valve includes:
a valve seat in which a passage is formed, wherein the passage allows an incoming fluid to flow from an outside of the valve seat into an inside of the valve seat;
a guide member fixed to the valve seat, and protruded towards the outside of the valve seat;
a piston which is disposed generally on the outside of the valve seat, forms a fluid inlet with the valve seat, and is capable of being reciprocated along the guide member; and
a biasing member biasing the piston in a direction away from the valve seat,
wherein an impact force exerted by the incoming fluid on the piston is opposite in direction to a biasing force exerted by the biasing member on the piston, and
the piston is able to be moved to different positions under the action of different impact forces to form fluid inlets of different widths with the valve seat.

In particular, the piston is movable between an upper limit position farthest from the valve seat and a lower limit position closest to the valve seat; and
between the upper limit position and the lower limit position, the smaller the impact force exerted by the incoming fluid on the piston is, the greater the width of the fluid inlet formed by the piston and the valve seat is.

In particular, the incoming fluid includes a gas or a liquid, or a mixture of gas and liquid.

In particular, the incoming fluid is a refrigerant.

The flow regulating valve further includes a stop member, which is disposed at a distal end of the guide member to prevent the piston from falling off from the guide member.

In particular, the stop member includes a clamping band.

In particular, the biasing member includes a helical spring, which is wound around a periphery of the guide member and which has one end abutted against the valve seat and the other end abutted against the piston.

In particular, between the upper limit position and the lower limit position, the smaller the impact force exerted by the incoming fluid on the piston is, the greater a length of the helical spring is, and thus the greater the width of the fluid inlet formed by the piston and the valve seat.

In accordance with another aspect of the present invention, there is provided a compressor. The compressor includes the abovementioned flow regulating valve, and the flow regulating valve is mounted in a suction duct of the compressor or on a suction side of the compressor.

In particular, the flow regulating valve is combined directly with a suction port of the compressor, or, the flow regulating valve is disposed between the suction port of the compressor and an external pipe, or, the external pipe is combined with the suction port of the compressor and the flow regulating valve is disposed in any appropriate position in the external pipe.

### Technical Effects

With the above technical solutions of the present invention, the flow rate of the fluid entering the compressor can be effectively adjusted with a simple structure and low cost.

In particular, by providing the compressor with the flow regulating valve according to the present invention, in the case where the incoming fluid contains liquid, the flow regulating valve can automatically reduce the width of the fluid inlet of the flow regulating valve, thereby preventing the fluid from quickly flowing into the compressor at an excessively high mass flow rate.

### BRIEF DESCRIPTION OF THE DRAWINGS

In order to facilitate understanding of the present invention, the present invention will be described in more detail based on exemplary embodiments in conjunction with the drawings. The same or similar reference numerals are used in the drawings to indicate the same or similar components. It should be understood that the drawings are only schematic, and the dimensions and proportions of components in the drawings are not necessarily accurate.

FIGS. 1A, 1B and 1C are schematic views showing different embodiments of a compressor with a flow regulating valve according to the present invention, respectively.

FIG. 2 is a schematic sectional view of a flow regulating valve according to the present invention when in a first state.

FIG. 3 is a schematic sectional view of the flow regulating valve according to the present invention when in a second state.

### DETAILED DESCRIPTION

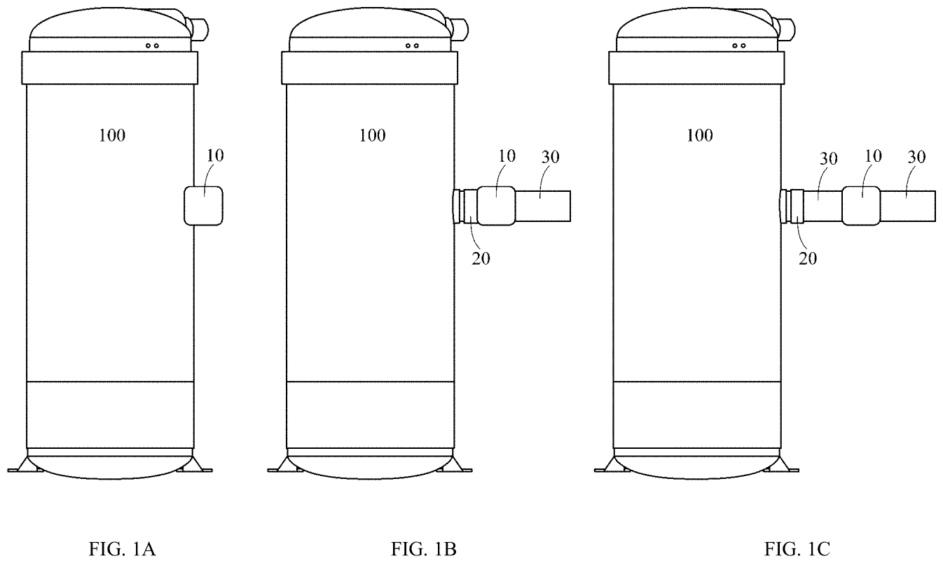

Main structure, working principle, and industrial applicability of the flow regulating valve and the compressor according to the present invention will be described below with reference to FIGS. 1A to 3.

[symbol] Main Structure

[symbol]

FIGS. 1A, 1B and 1C are schematic views showing different embodiments of a compressor 100 with a flow regulating valve according to the present invention, respectively. In the embodiment shown in FIG. 1A, the flow regulating valve 10 may be combined directly with a suction port of the compressor 100. In the embodiment shown in FIG. 1B, the flow regulating valve 10 may be disposed between the suction port 20 of the compressor 100 and an external pipe 30. In the embodiment shown in FIG. 1C, the external pipe 30 is combined with the suction port 20 of the compressor 100, and the flow regulating valve 10 may be disposed in any appropriate position in the external pipe 30.

It is worth mentioning that FIGS. 1A to 1C show only examples in which the flow regulating valve is mounted on a suction side of the compressor. However, according to the present invention, the flow regulating valve may also be mounted in a discharge pipe of the compressor or on a discharge side of the compressor, or may be mounted in any pipe where the flow rate of fluid needs to be adjusted. Furthermore, the flow regulating valve according to the present invention may be used in not only the compressor, but also any machine where the flow rate needs to be adjusted.

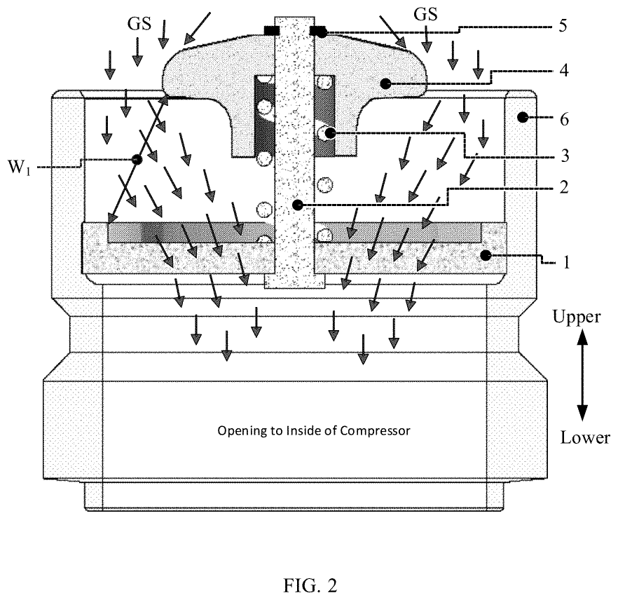

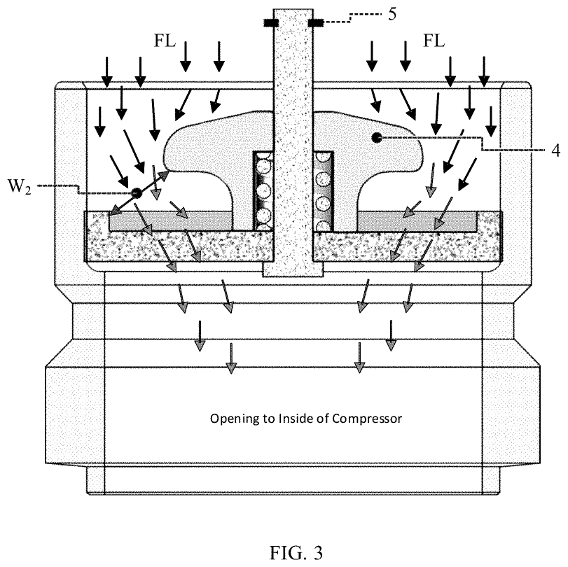

As shown in FIGS. 2 and 3, the flow regulating valve 10 includes a valve seat 1, a guide member 2, a biasing member 3, a piston 4, a stop member 5 and a pipe 6. A passage is formed in the valve seat 1 to allow fluid to flow from an outside of the valve seat 1 into an inside of the valve seat 1 (for example, into an inside of the compressor). The valve seat 1, the piston 4, and the pipe 6 form a fluid regulating passage, and the piston 4 is able to be movable away from or towards the valve seat 1 along the guide member 2 such that a narrowest section of the fluid regulating passage is changed in width and/or in position.

The guide member 2 is fixed to the valve seat 1, and is protruded towards the outside of the valve seat 1. The guide member 2 has a cylindrical shape. The guide member 2 is independent of the piston 4 and the valve seat 1, or the guide member 2 and the piston 4 are an integral member formed by an integrally molding process, or the guide member 2 and the valve seat 1 are an integral member formed by an integrally molding process.

The piston 4 is disposed generally on the outside of the valve seat 1, forms a fluid inlet with the valve seat 1, and is capable of being reciprocated along the guide member 2. The biasing member 3 biases the piston 4 in a direction away from the valve seat 1 (upwards as shown in FIG. 2). The stop member 5 is disposed at a distal end of the guide member 2 to prevent the piston 4 from falling off from the guide member 2. The stop member 5 may be a clamping band. The biasing member 3 may be a helical spring wound around a periphery of the guide member 2. The helical spring has a lower end abutted against the valve seat 1 and an upper end abutted against the piston 4. The flow regulating valve 10 may further include a linkage member (not shown in FIGS. 2 and 3). The linkage member is disposed between the biasing member 3 and the piston 4 and is able to be linked with the piston 4. The biasing member 3 is abutted against the linkage member such that the biasing force acts on the linkage member. An impact force exerted by the incoming fluid on the piston 4 is generally opposite in direction to a biasing force exerted by the biasing member 3 on the piston 4. In other words, the incoming fluid pushes the piston 4 downwards, while the biasing member 3 pushes the piston 4 upwards.

The incoming fluid may be a gas, as the fluid GS shown in FIG. 2. The incoming fluid may also be a liquid, or a mixture of gas and liquid, as the fluid FL shown in FIG. 3. According to the technical solution of the present invention, the incoming fluid may be a refrigerant.

An impact force exerted by the incoming fluid on the piston 4 varies depending on a state and/or a mass flow rate of the incoming fluid. The piston 4 is able to be moved to different positions along the guide member 2 under the action of different impact forces to form fluid inlets of different widths with the valve seat 1. The piston 4 is movable between an upper limit position farthest from the valve seat 1 and a lower limit position closest to the valve seat 1.

Specifically, FIG. 2 shows a state when the piston 4 is in the upper limit position and FIG. 3 shows a state when the piston 4 is in the lower limit position. Between the upper limit position and the lower limit position, the smaller the impact force exerted by the incoming fluid on the piston 4 is, the greater a length of the helical spring is, the higher a position of the piston 4 is, and the greater the width of the fluid inlet formed by the piston 4 and the valve seat 1 is, and vice versa. For example, the width of the fluid inlet formed by the piston 4 and the valve seat 1 is W₁ in the state shown in FIG. 2, the width of the fluid inlet formed by the piston 4 and the valve seat 1 is W₂ in the state shown in FIG. 3, and W₁>W₂.

It should be appreciated that the mass flow rate of the fluid is limited by the width of the narrowest section of the fluid inlet, rather than a wider section of the fluid inlet. Therefore, the width (such as W₁ and W₂) of the fluid inlet mentioned herein generally refers to the width of the narrowest section of the fluid inlet.

In addition, although FIGS. 2 and 3 show the case where the width (such as W₁ and W₂) of the narrowest section of the fluid inlet is determined by the piston 4 and the valve seat 1, it should be appreciated that the width of the narrowest section of the fluid inlet may also be determined by the piston 4 and the pipe 6.

### Working Principle

For example, in the state shown in FIG. 2, an upper surface of the piston 4 is impacted by the fluid GS (which may be considered to contain no liquid component or only a small amount of liquid component). Since the mass flow rate of the fluid GS is small, the impact force on the piston 4 is small. Therefore, the biasing force exerted by the biasing member 3 on the piston 4 can overcome the impact force exerted by the fluid GS on the piston 4, thereby pushing the piston 4 upwards so that the piston 4 is abutted against the stop member 5. As a result, the width W₁ of the formed fluid inlet is greater.

However, in the state shown in FIG. 3, since the fluid FL contains more liquid component (even all the fluid FL is liquid), the mass flow rate is greater. The impact force exerted by the fluid FL on the piston 4 is greater. Hence, the biasing force exerted by the biasing member 3 on the piston 4 cannot overcome the impact force exerted by the fluid GS on the piston 4. Therefore, the piston 4 is pushed downwards to be abutted against the valve seat 1. As a result, the width W₂ of the formed fluid inlet is smaller. Since the width of the fluid inlet is reduced, the liquid in the fluid FL is blocked, so that the liquid is prevented from flowing into the compressor quickly to cause damage to the compressor.

It should be noted that the reduction of the width of the fluid inlet as described above does not significantly affect the flow rate of the incoming gas, but slows only the flow rate of the incoming liquid. Such an effect had been experimentally confirmed, and is also exactly a desired effect.

In addition, although the cases where the piston 4 is in the upper limit position and the lower limit position is emphatically described with reference to FIGS. 2 and 3 above, it is conceivable that the piston 4 may also be in any position between the upper limit position and the lower limit position based on the magnitude of the mass flow rate of the incoming fluid. Accordingly, the width of the formed fluid inlet is between W₂ and W₁.

It can be appreciated that in the above technical solution, while the width of the narrowest section of the fluid inlet is adjusted, the position of the narrowest section of the fluid inlet is also actually adjusted. Based on the above technical solution disclosed in the present invention, those skilled in the art could conceive a technical solution in which only the width of the narrowest section of the fluid inlet is adjusted, but the position of the narrowest section of the fluid inlet is not adjusted, and a technical solution in which only the position of the narrowest section of the fluid inlet is adjusted, but the width of the narrowest section of the fluid inlet is not adjusted.

The flow regulating valve according to the present invention can be widely used in various machines including a compressor.

Although the technical objects, technical solutions, and technical effects of the present invention have been described in detail above with reference to the specific embodiments, it should be understood that the above embodiments are only exemplary, but are not restrictive. All of the modifications, equivalent substitutions and improvements made by those skilled in the art without departing from the principles and spirit of the present invention should fall within the protection scope of the present invention.

What is claimed is:

1. A flow regulating valve, wherein the flow regulating valve is able to form fluid inlets of different widths according to different forces exerted on the flow regulating valve by an incoming fluid.

2. The flow regulating valve of claim 1, wherein:
the flow regulating valve comprises a valve seat, a guide member, a piston, and a pipe, wherein the valve seat, the piston, and the pipe form a fluid regulating passage, and the piston is movable away from or towards the valve seat along the guide member such that a narrowest section of the fluid regulating passage is changed in width and/or in position.

3. The flow regulating valve of claim 2, wherein:
the flow regulating valve further comprises a biasing member, both a biasing force generated by the biasing member and the force generated by the incoming fluid act on the piston such that the piston is moved along the guide member and finally reaches an equilibrium state.

4. The flow regulating valve of claim 3, wherein:
the width of the narrowest section of the fluid regulating passage is determined by the piston and the valve seat or by the piston and the pipe.

5. The flow regulating valve of claim 2, wherein:
the guide member is independent of the piston and the valve seat, or the guide member and the piston are an integral member, or the guide member and the valve seat are an integral member.

6. The flow regulating valve of claim 3, wherein:
the biasing member is abutted against the piston such that the biasing force acts directly on the piston.

7. The flow regulating valve of claim 3, wherein:
the flow regulating valve further comprises a linkage member, the linkage member is disposed between the biasing member and the piston and is able to be linked with the piston, and
the biasing member is abutted against the linkage member such that the biasing force acts on the linkage member.

8. The flow regulating valve of claim 2, wherein:
the incoming fluid comprises a gas or a liquid, or a mixture of gas and liquid.

9. The flow regulating valve of claim 3, wherein:
the biasing member comprises a spring.

10. The flow regulating valve of claim 3, wherein:
the smaller the force exerted by the incoming fluid on the piston is, the greater the width of the formed fluid inlet is.

11. A compressor, wherein the compressor comprises the flow regulating valve according to claim 1, and the flow regulating valve is mounted in a suction duct of the compressor or on a suction side of the compressor.

12. The flow regulating valve of claim 2, wherein:
the width of the narrowest section of the fluid regulating passage is determined by the piston and the valve seat or by the piston and the pipe.

13. The flow regulating valve of claim 1, wherein:
the incoming fluid comprises a gas or a liquid, or a mixture of gas and liquid.

14. The compressor, wherein the compressor comprises the flow regulating valve according to claim 2, and the flow regulating valve is mounted in a suction duct of the compressor or on a suction side of the compressor.

15. The compressor, wherein the compressor comprises the flow regulating valve according to claim 3, and the flow regulating valve is mounted in a suction duct of the compressor or on a suction side of the compressor.

16. The compressor, wherein the compressor comprises the flow regulating valve according to claim 4, and the flow regulating valve is mounted in a suction duct of the compressor or on a suction side of the compressor.

17. The compressor, wherein the compressor comprises the flow regulating valve according to claim 5, and the flow regulating valve is mounted in a suction duct of the compressor or on a suction side of the compressor.

18. The compressor, wherein the compressor comprises the flow regulating valve according to claim 6, and the flow regulating valve is mounted in a suction duct of the compressor or on a suction side of the compressor.

19. The compressor, wherein the compressor comprises the flow regulating valve according to claim 7, and the flow regulating valve is mounted in a suction duct of the compressor or on a suction side of the compressor.

20. The compressor, wherein the compressor comprises the flow regulating valve according to claim 8, and the flow regulating valve is mounted in a suction duct of the compressor or on a suction side of the compressor.
